(19) United States
(12) Patent Application Publication
(10) Pub. No.: US 2014/0008395 A1
(43) Pub. Date: Jan. 9, 2014

(54) Zero Waste Dispensing Bottle

(71) Applicants: Zia Hossain Syed, Pflugerville, TX (US); Ryan Shakir Syed, Pflugerville, TX (US)

(72) Inventors: Zia Hossain Syed, Pflugerville, TX (US); Ryan Shakir Syed, Pflugerville, TX (US)

(21) Appl. No.: 13/727,553

(22) Filed: Dec. 26, 2012

Related U.S. Application Data
(60) Provisional application No. 61/610,985, filed on Mar. 14, 2012.

(51) Int. Cl. B65D 88/54; B67D 7/78; B67D 7/58

(52) U.S. Cl. CPC B05B 11/3042
USPC 222/321.5; 222/382; 222/377; 222/464.7

(57) ABSTRACT

Traditional hand pump dispenser found in common household cannot dispense 100% of the product it contains in the container. This invention relates to devices, systems and methods for dispensing, distributing or delivering a substance from the dispensing container. More particularly, the invention relates to a device and method for dispensing a liquid (e.g., a cleaner, disinfectant, deodorizer, moisturizer, medication, etc.) more effectively. Furthermore, the invention allows users to access the dispensing material when the hand pump cannot be primed due to the level of the fluid in the container. This new dispensing bottle will eliminate waste to almost zero.

### TECHNICAL INFORMATION

### Summary of the Invention

The present invention meets the foregoing need to be able to use the entire product that is contained in a hand pump dispenser. In one aspect, the invention provides a ‘Well’ at the tip of the dispensing end tube so that the effectiveness of the hand pump is primed longer and be able to extract the most fluid out of the container. In another aspect, it provides an access to the product from the bottom of the container when it is almost empty so that the product can be used to the last drop from the container regardless of the shape of the container.

### DETAIL DESCRIPTION

The traditional hand pump provided on household dispenser losses its effectiveness when the liquid level falls to a certain level, and the pump looses its prime. The afford mention deficiencies and inadequacy is addressed by this invention in two ways. In one embodiment it provides a ‘well’ to support the hand pump effectiveness longer, the ‘well’ also allows the liquid to flow into it automatically through gravity as the container gets emptier. Second, when the pump cannot pump any more products out of the container, the invention allows access to the product from the bottom of the container and allows scrubbing the residual product.

### BRIEF DESCRIPTION OF THE DRAWINGS

On each Drawing

FIG. 1 is the three dimensional view from the bottom of the container,

FIG. 2 is the front view,

FIG. 3 is the bottom view and

FIG. 4 is the front view of the detachable bottom cap of the container.

FIG. 5 is the partial sectional view of the bottom part of the bottle

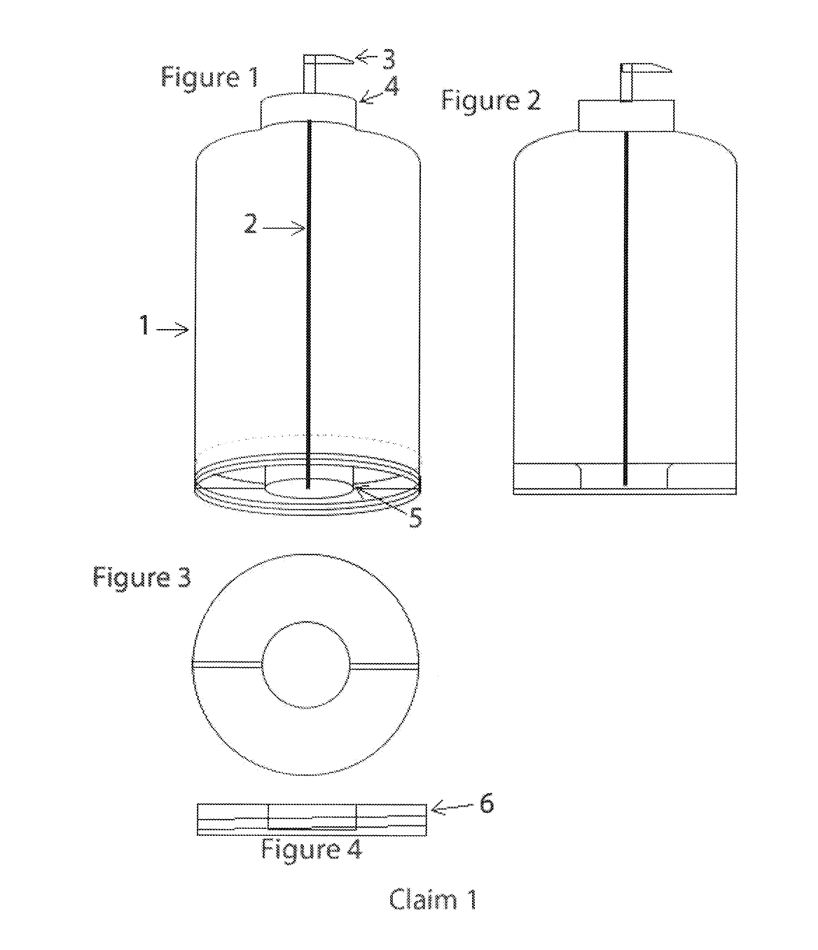

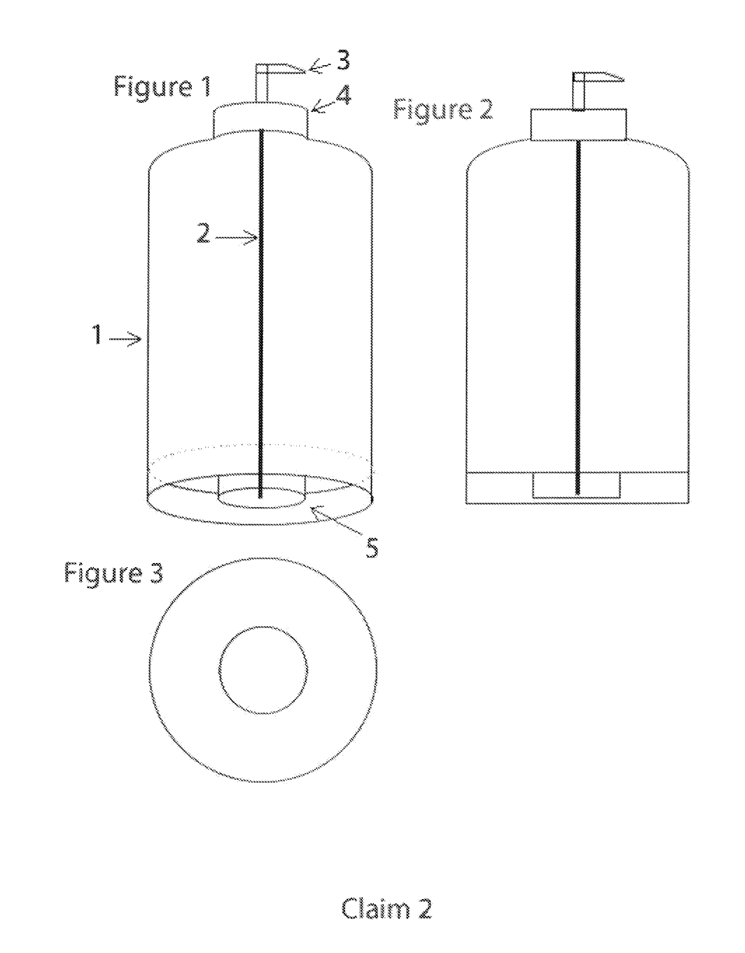

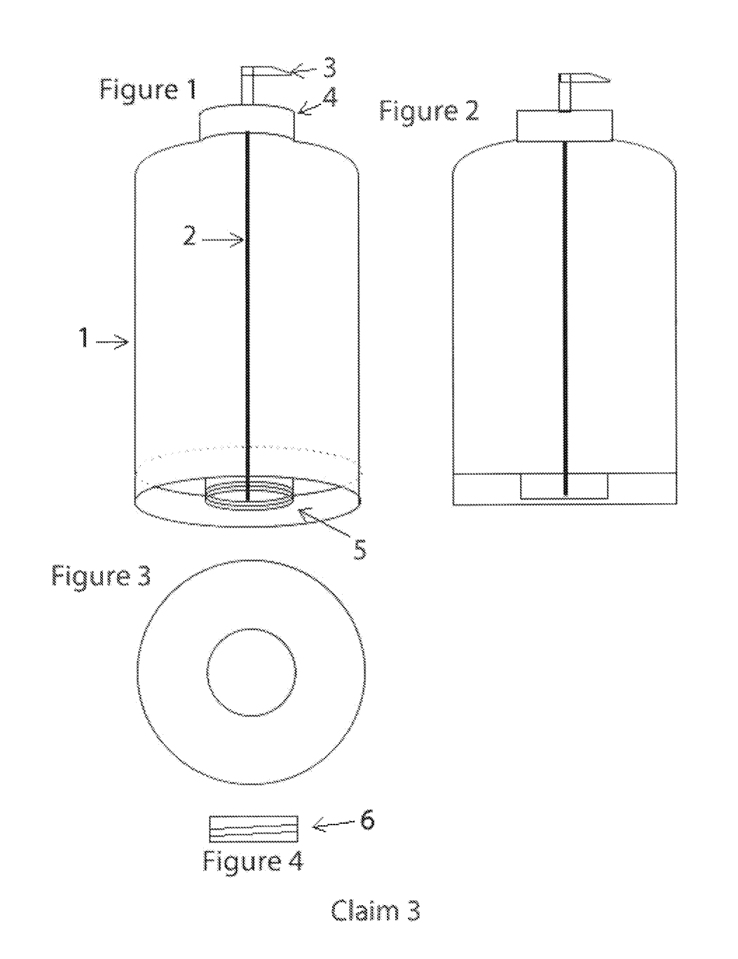

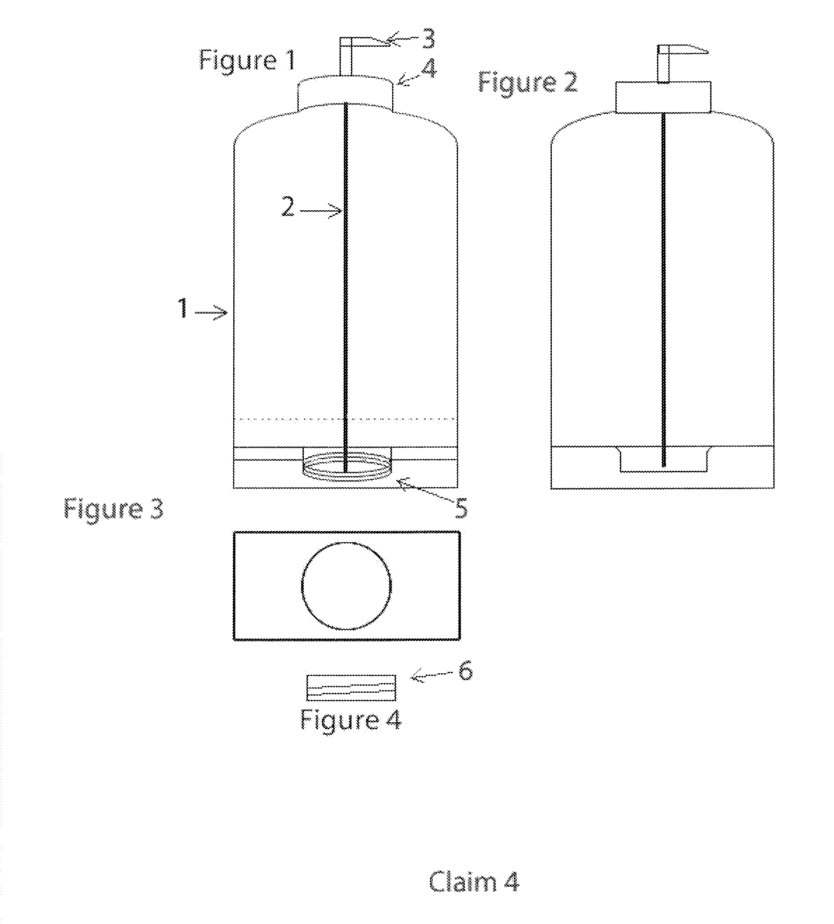

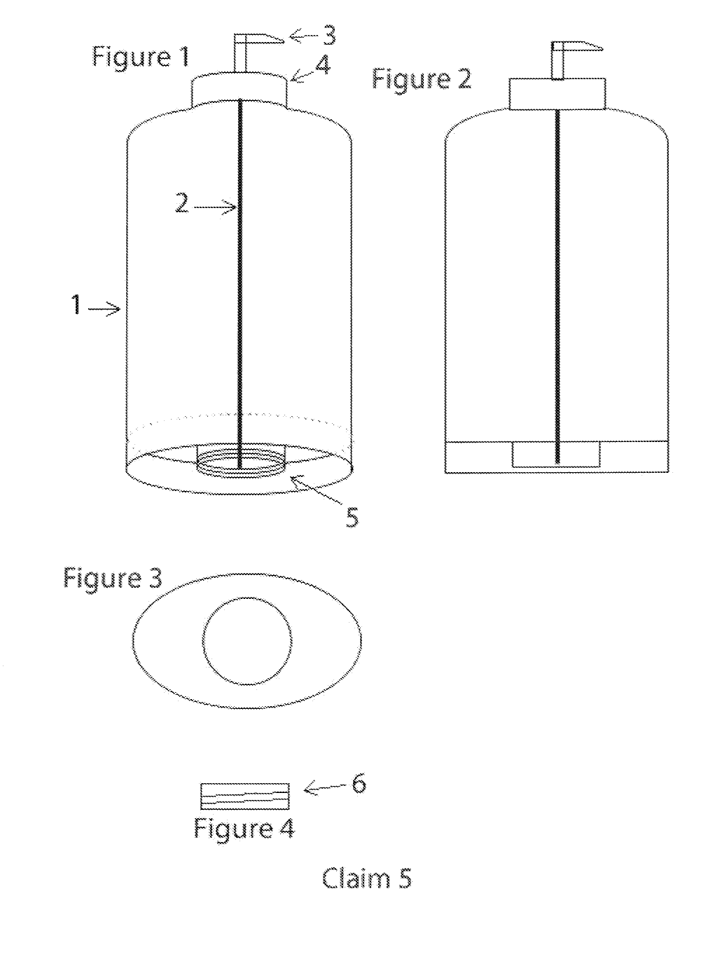

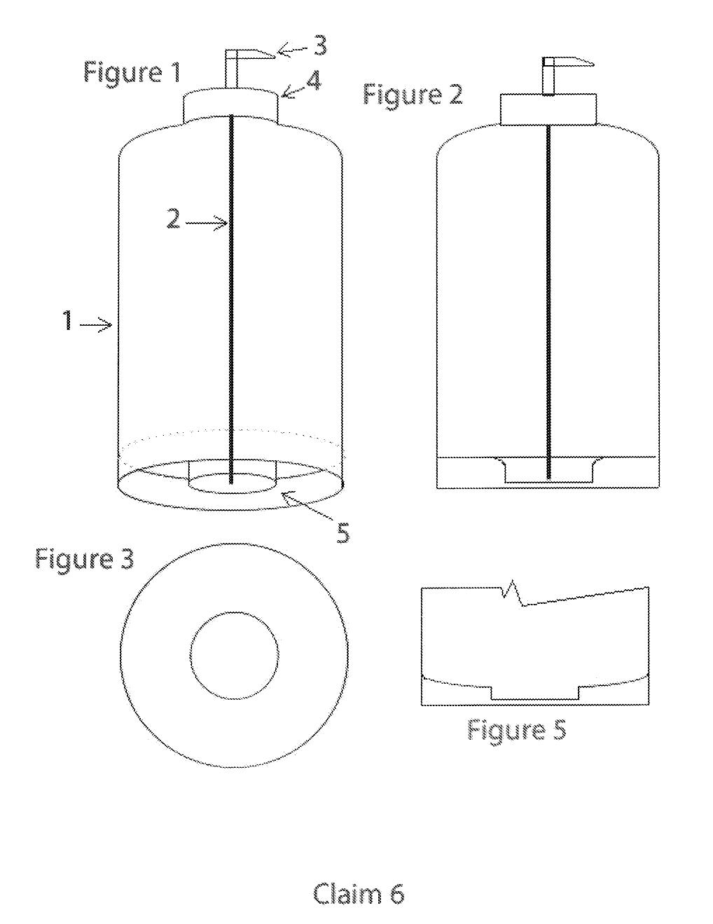

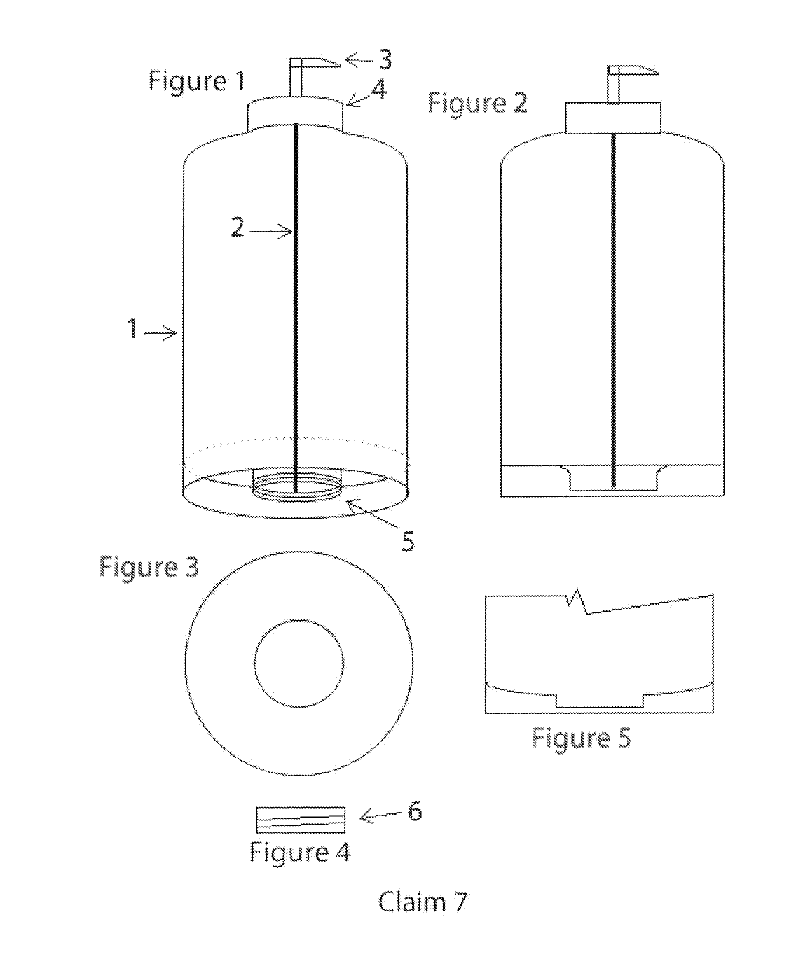

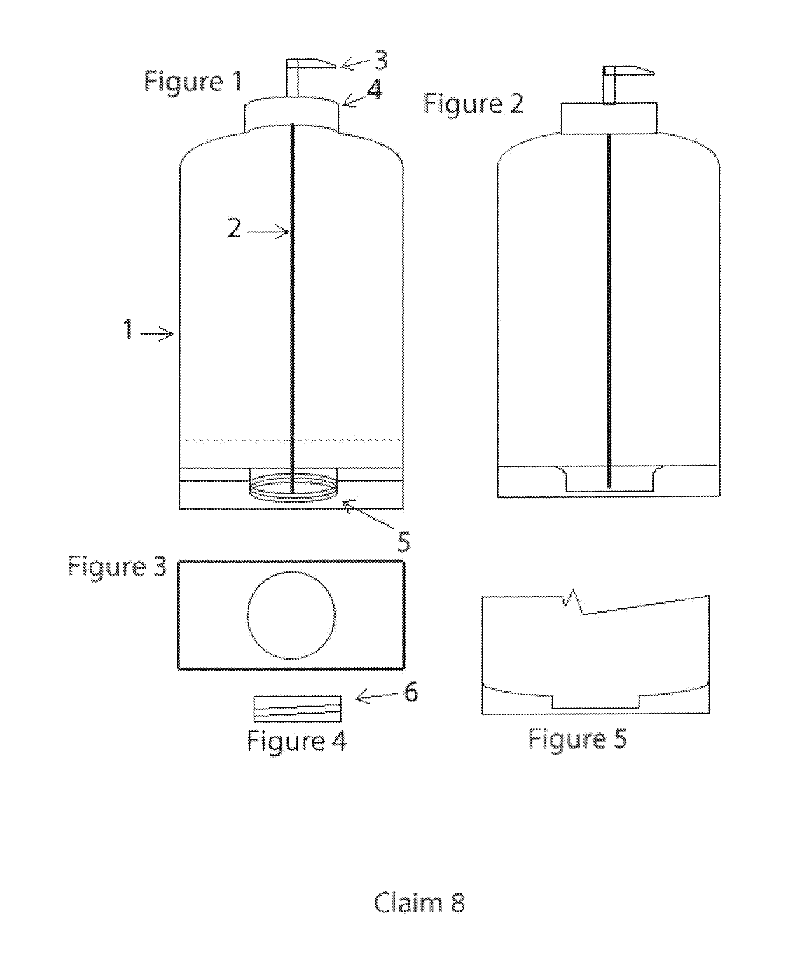

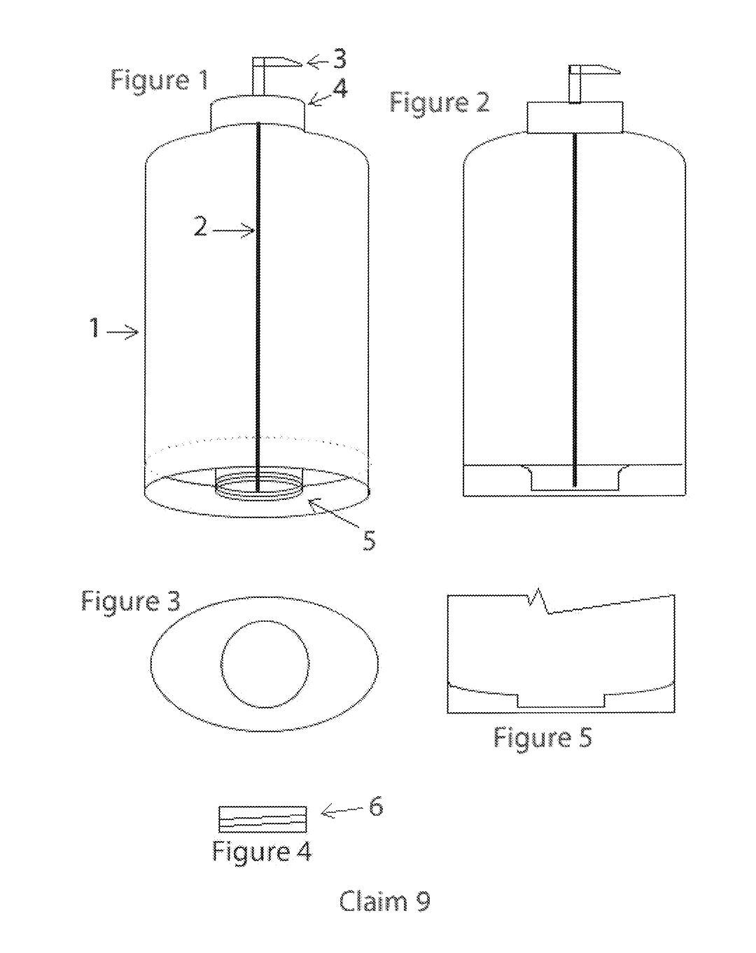

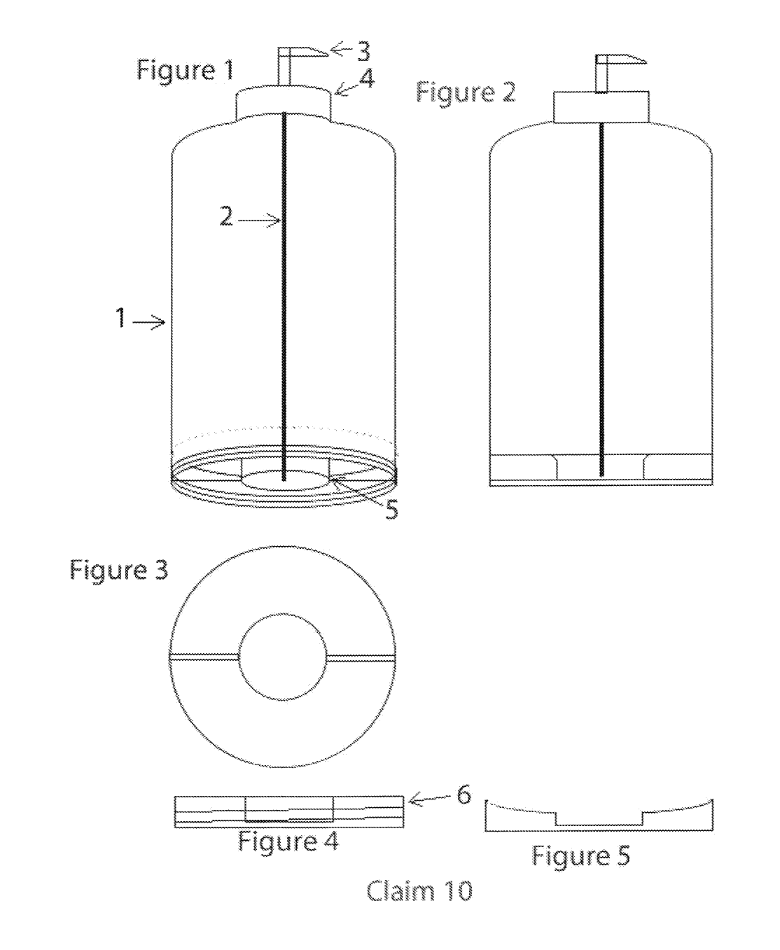

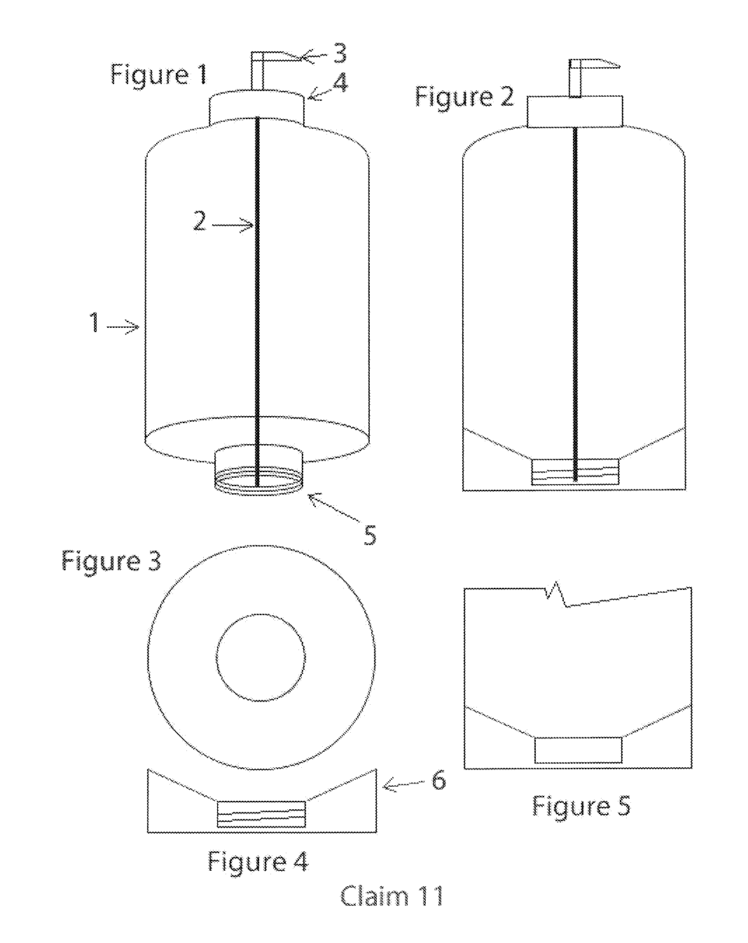

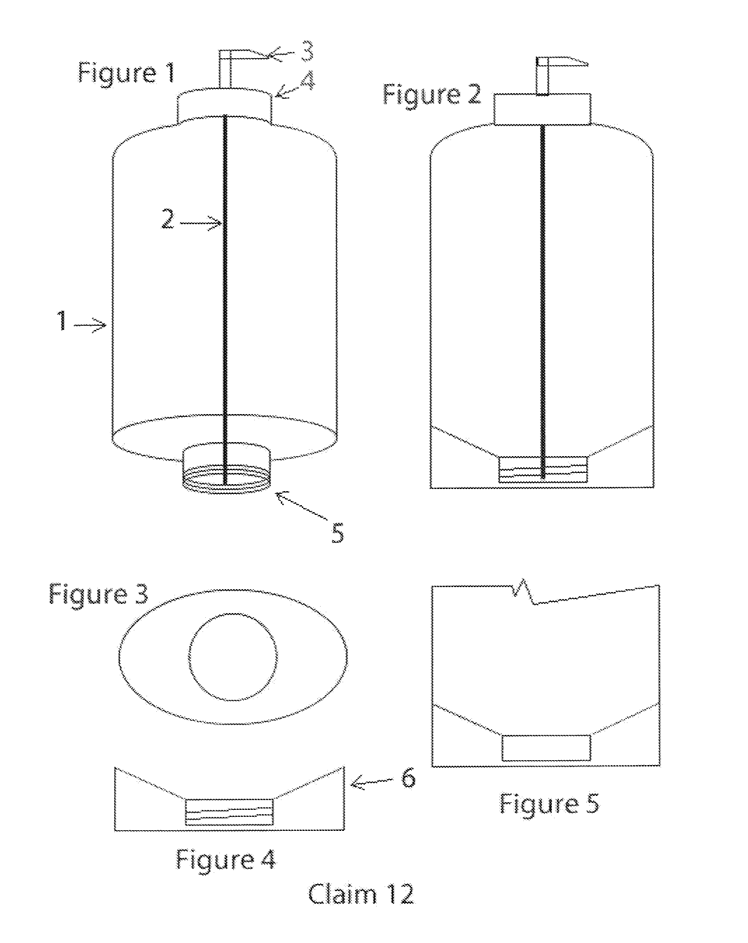

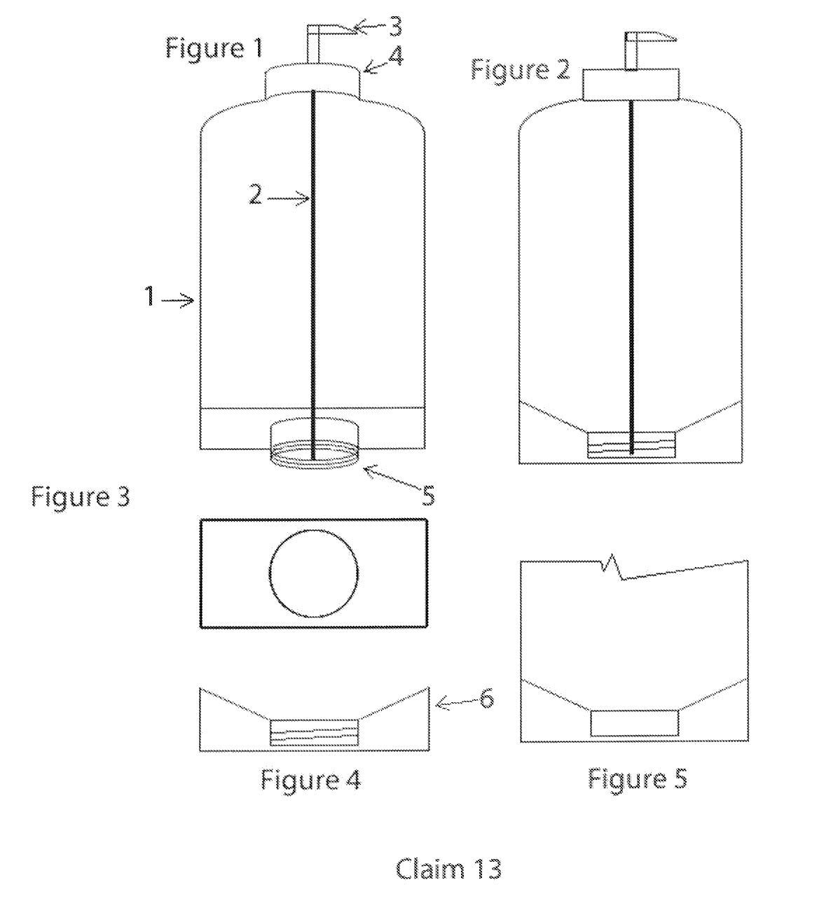

1. In the Drawing claim 1, represents a circular shape bottle dispenser. FIG. 1 shows a 3-dimensional view of the circular container. Part No. 1 is the body of the dispenser, part no 2 is the tube of the hand pump shown in part no. 3. Part no. 4 is the top cap of the dispenser and part no. 6 is the detachable bottom cap of the dispenser. Part no. 5 is the bottom well provided to the hand pump so that part no. 2 reaches the well's bottom. Part no. 6 has external threads so that it fits in the internal threaded bottom of part no 1. FIGS. 2 and 3 are the front and bottom view of FIG. 1 respectively. FIG. 4 shows the side view of the detachable bottom cap.
In the Drawing claim 2, represents a circular shape bottle dispenser. FIG. 1 shows a 3-dimensional view of the circular container. Part No. 1 is the body of the dispenser, part no 2 is the tube of the hand pump shown in part no. 3. Part no. 4 is the top cap of the dispenser. Part no. 5 is the bottom well provided to the hand pump so that part no. 2 reaches the well's bottom. Part no. 5 is fixed and not removable. FIG. 2 is the front view of FIG. 1 respectively. FIG. 3 shows the bottom view of the not detachable bottom cap.
In the Drawing claim 3, represents a circular shape bottle dispenser. FIG. 1 shows a 3-dimensional view of the circular container. Part No. 1 is the body of the dispenser, part no 2 is the tube of the hand pump shown in part no. 3. Part no. 4 is the top cap of the dispenser and part no. 6 is the detachable bottom cap of the dispenser. Part no. 5 is the bottom well provided to the hand pump so that part no. 2 reaches the well's bottom. Part no. 6 has an internal thread which fits in the bottom well of the external thread of part no 5. FIGS. 2 and 3 are the front and bottom view of FIG. 1 respectively. FIG. 4 shows the side view of the detachable bottom cap.
In the Drawing claim 4, represents a rectangular/square shape bottle dispenser. FIG. 1 shows a 3-dimensional view of the rectangular/square container. Part No. 1 is the body of the dispenser, part no 2 is the tube of the hand pump shown in part no. 3. Part no. 4 is the top cap of the dispenser and part no. 6 is the detachable bottom cap of the dispenser. Part no. 5 is the bottom well provided to the hand pump so that part no. 2 reaches the well's bottom. Part no. 6 has an internal thread which fits in the bottom well of the external thread of part no 5. FIGS. 2 and 3 are the front and bottom view of FIG. 1 respectively. FIG. 4 shows the side view of the detachable bottom cap.
In the Drawing claim 5, represents a elliptical shape bottle dispenser. FIG. 1 shows a 3-dimensional view of the elliptical container. Part No. 1 is the body of the dispenser, part no 2 is the tube of the hand pump shown in part no. 3. Part no. 4 is the top cap of the dispenser and part no. 6 is the detachable bottom cap of the dispenser. Part no. 5 is the bottom well provided to the hand pump so that part no. 2 reaches the well's bottom. Part no. 6 has an internal thread which fits in the bottom well of the external thread of part no 5. FIGS. 2 and 3 are the front and bottom view of FIG. 1 respectively. FIG. 4 shows the side view of the detachable bottom cap.
In the Drawing claim 6, represents a circular shape bottle dispenser. FIG. 1 shows a 3-dimensional view of the circular container. Part No. 1 is the body of the dispenser, part no 2 is the tube of the hand pump shown in part no. 3. Part no. 4 is the top cap of the dispenser. Part no. 5 is the bottom well provided to the hand pump so that part no. 2 reaches the well's bottom. Part no. 5 is fixed and not removable. FIGS. 2 and 3 are the front and bottom view of FIG. 1 respectively. FIG. 4 shows the side view of the detachable bottom cap. The bottom floor of part 1 is curves and sloped towards the well as show in FIG. 5.
In the Drawing claim 7, represents a circular shape bottle dispenser. FIG. 1 shows a 3-dimensional view of the circular container. Part No. 1 is the body of the dispenser, part no 2 is the tube of the hand pump shown in part no. 3. Part no. 4 is the top cap of the dispenser and part no. 6 is the detachable bottom cap of the dispenser. Part no. 5 is the bottom well provided to the hand pump so that part no. 2 reaches the well's bottom. Part no. 6 has an internal thread which fits in the bottom well of the external thread of part no 5. FIGS. 2 and 3 are the front and bottom view of FIG. 1 respectively. FIG. 4 shows the side view of the detachable bottom cap. The bottom floor of part 1 is curves and sloped towards the well as show in FIG. 5.
In the Drawing claim 8, represents a rectangular shape bottle dispenser. FIG. 1 shows a 3-dimensional view of the rectangular container. Part No. 1 is the body of the dispenser, part no 2 is the tube of the hand pump shown in part no. 3. Part no. 4 is the top cap of the dispenser and part no. 6 is the detachable bottom cap of the dispenser. Part no. 5 is the bottom well provided to the hand pump so that part no. 2 reaches the well's bottom. Part no. 6 has an internal thread which fits in the bottom well of the external thread of part no 5. FIGS. 2 and 3 are the front and bottom view of FIG. 1 respectively. FIG. 4 shows the side view of the detachable bottom cap. The bottom floor of part 1 is curves and sloped towards the well as show in FIG. 5.
In the Drawing claim 9, represents an elliptical shape bottle dispenser. FIG. 1 shows a 3-dimensional view of the elliptical container. Part No. 1 is the body of the dispenser, part no 2 is the tube of the hand pump shown in part no. 3. Part no. 4 is the top cap of the dispenser and part no. 6 is the detachable bottom cap of the dispenser. Part no. 5 is the bottom well provided to the hand pump so that part no. 2 reaches the well's bottom. Part no. 6 has an internal thread which fits in the bottom well of the external thread of part no 5. FIGS. 2 and 3 are the front and bottom view of FIG. 1 respectively. FIG. 4 shows the side view of the detachable bottom cap. The bottom floor of part 1 is curves and sloped towards the well as show in FIG. 5.
Claim 10, represents a circular shape bottle dispenser. FIG. 1 shows a 3-dimensional view of the circular container. Part No. 1 is the body of the dispenser, part no 2 is the tube of the hand pump shown in part no. 3. Part no. 4 is the top cap of the dispenser and part no. 6 is the detachable bottom cap of the dispenser. Part no. 5 is the bottom well provided to the hand pump so that part no. 2 reaches the well's bottom. Part no. 5 has external threads so that it fits in the internal threaded bottom of part no 1. FIGS. 2 and 3 are the front and bottom view of FIG. 1 respectively. FIG. 4 shows the side view of the detachable bottom cap. The bottom cap (part no. 6) is curved and sloped towards the well as show in FIG. 6, which is cross sectional view of part no 5.
Claim 11 is a round bottle that has two openings, top and bottom; FIG. 1 shows a 3-dimensional view of the circular container. Part No. 1 is the body of the dispenser, part no 2 is the tube of the hand pump shown in part no. 3. Part no. 4 is the top cap of the dispenser and part no. 6 is the detachable bottom cap of the dispenser. Part no. 5 is the bottom well provided to the hand pump so that part no. 2 reaches the well's bottom. Part no. 6 has an internall threads so that it fits in the external threaded bottom of part no 1. FIGS. 2 and 3 are the front and bottom view of FIG. 1 respectively. FIG. 4 shows the side view of the detachable end cap.
Claim 12, represents a oval shape bottle dispenser. FIG. 1 shows a 3-dimensional view of the oval container. Part No. 1 is the body of the dispenser, part no 2 is the tube of the hand pump shown in part no. 3. Part no. 4 is the top cap of the dispenser and part no. 6 is the detachable bottom cap of the dispenser. Part no. 5 is the bottom well provided to the hand pump so that part no. 2 reaches the well's bottom. Part no. 6 has an internal threads so that it fits in the external threaded bottom of part no 1. FIGS. 2 and 3 are the front and bottom view of FIG. 1 respectively. FIG. 4 shows the side view of the detachable bottom cap.
Claim 13, represents a rectangular shape bottle dispenser. FIG. 1 shows a 3-dimensional view of the rectangular container. Part No. 1 is the body of the dispenser, part no 2 is the tube of the hand pump shown in part no. 3. Part no. 4 is the top cap of the dispenser and part no. 6 is the detachable bottom cap of the dispenser. Part no. 5 is the bottom well provided to the hand pump so that part no. 2 reaches the well's bottom. Part no. 6 has an internal threads so that it fits in the external threaded bottom of part no 1. FIGS. 2 and 3 are the front and bottom view of FIG. 1 respectively. FIG. 4 shows the side view of the detachable bottom cap.
